(19) United States
(12) Patent Application Publication
(10) Pub. No.: US 2020/0134544 A1
(43) Pub. Date: Apr. 30, 2020

(54) Systems, Methods and Devices for Donation of Unsaleable Inventory

(71) Applicant: Waste Repurposing International, Inc., Austin, TX (US)

(72) Inventors: Christopher B. Ripley, Lichtfield, CT (US); Charles Bartol Vallely, Austin, TX (US)

(73) Assignee: Waste Repurposing International, Inc., Austin, TX (US)

(21) Appl. No.: 16/176,733

(22) Filed: Oct. 31, 2018

(51) Int. Cl. G06Q 10/08; G06K 9/62; G06Q 10/00; G06F 9/451

(52) U.S. Cl. CPC G06Q 10/087; G06Q 10/0832; G06F 9/453; G06Q 10/30; G06K 9/6281

(57) ABSTRACT

In some embodiments, a system may include an sorter device including at least one optical device configured to capture optical data associated with an unsaleable item, a display, and a processor coupled to the at least one optical device and to the display. The processor may be configured to automatically identify the unsaleable item, to provide a graphical interface to the display including selectable options accessible by a user to assign the identified unsaleable item to a selected donation site of a plurality of donation sites. In response to selection of the selected donation site, the processor may be configured to guide an operator through a process of packaging the unsaleable item into a shipping container for transport. The sorter device may track the process to confirm acceptance of the donation and confirmation of receipt of the donation by a receiver at the donation site.

### FIELD

The present disclosure is generally related to unsaleable inventory, and more particularly, to systems, methods, and devices configured to facilitate, track, and document donations of unsaleable inventory.

### BACKGROUND

Retail stores typically include inventory on shelves and in storage. Sometimes, products may become unsaleable. In general, unsaleable products are items that can no longer be sold at some point in the supply chain. Such unsaleable products may include products with damaged product packaging, irregular looking products (e.g., bent or irregular shaped carrots), blemished fruit, products that do not sell or that are slow to sell, clothing items that don't sell, partial packages of a multi-pack product, and so on. In some embodiments, unsaleable products may also include customer-returned products. These products may still be useable even if they cannot be sold.

### SUMMARY

Embodiments of systems, methods, and devices disclosed herein may be configured to identify contents of a particular unsaleable product, and to appropriately classify each unsaleable item or product into at least one of a donation bin, a reuse bin, and a disposal bin. In a particular embodiment, the system may include a sorter device that can be configured to scan or otherwise capture image data associated with an unsaleable item and to utilize the image data to automatically determine if the unsaleable item can be donated. When the unsaleable item can be donated, the sorter device may provide a graphical interface including a selected donation site to a display of the sorter device. In some embodiments, the sorter device may track the sorted donation items and may acquire confirmation from an authorized representative of the donation site to confirm receipt of the donated items. Other embodiments are also possible.

In some embodiments, a system may include an sorter device including at least one optical device configured to capture optical data associated with an unsaleable item, a display, and a processor coupled to the at least one optical device and to the display. The processor may be configured to automatically identify the unsaleable item, to provide a graphical interface to the display including selectable options accessible by a user to assign the identified unsaleable item to a selected donation site of a plurality of donation sites. In response to selection of the selected donation site, the processor may be configured to guide an operator through a process of packaging the unsaleable item into a shipping container for transport. The sorter device may track the process to confirm acceptance of the donation and confirmation of receipt of the donation by a receiver at the donation site.

In some embodiments, a sorter device can include at least one optical device configured to capture optical data associated with an unsaleable item, a display, and a processor coupled to the at least one optical device and to the display. The processor may be configured to automatically identify the unsaleable item from the optical data, determine a recommended donation site from a plurality of donation sites for the unsaleable item based on the identification, and provide a graphical interface including the recommended donation site to the display.

In other embodiments, a sorter device can include at least one optical device configured to capture optical data associated with an unsaleable item, a display, and a processor coupled to the at least one optical device and to the display. The processor may be configured to automatically identify the unsaleable item from the optical data and to determine whether the identified unsaleable item can be donated based on a set of product handling rules. The processor may be further configured to automatically determine a recommended donation site from a plurality of donation sites for the identified unsaleable item based on the identification when the identified unsaleable item can be donated. The processor may be configured to provide a graphical interface to the display indicating the recommended donation site.

In still other embodiments, a method can include scanning an unsaleable item using an optical sensor of a sorter device to capture optical data and automatically identifying the unsaleable item based on the optical data using a processor of the sorter device. The method may further include automatically selecting a donation site of a plurality of donation sites based on information corresponding to the identified unsaleable item and providing a graphical interface to a display of the sorter device. The graphical interface may include the selected donation site.

### BRIEF DESCRIPTION OF THE DRAWINGS

FIG. 1 depicts a block diagram of a system including an item sorter device configured to facilitate donations of unsaleable inventory, in accordance with certain embodiments of the present disclosure.

FIG. 2 depicts a block diagram of a system including an item sorter device configured to facilitate donations of unsaleable inventory, in accordance with certain embodiments of the present disclosure.

FIG. 3 depicts a method of donating an unsaleable item, in accordance with certain embodiments of the present disclosure.

FIG. 4 depicts a method of donating an unsaleable item, in accordance with certain embodiments of the present disclosure.

FIG. 5 depicts a method of donating an unsaleable item, in accordance with certain embodiments of the present disclosure.

FIG. 6 depicts a graphical interface for presentation to a display of the item sorter device of FIGS. 1 and 2, in accordance with certain embodiments of the present disclosure.

FIG. 7 depicts a diagram of a partial donation record, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of systems, methods, and devices are described below that can be used to identify unsaleable products optically and to classify the unsaleable products automatically to determine whether the unsaleable product can be donated. When the unsaleable product can be donated, the systems, methods, and devices include providing a graphical interface to a display of a sorter device. The graphical interface may include selectable options including a list of donation sites. In some embodiments, the graphical interface may include a recommended donation site. The recommendation may be based on information about the unsaleable product, information about the donation site, timing information, other information, or any combination thereof.

In some embodiments, upon selection of an unsaleable item or product for donation, the system may automatically send an alert to a computing system associated with the donation site. In some embodiments, the alert may request authorization from the donation site, indicating that the donation site is willing to accept the donation. In response to receiving the authorization, the system may be configured to schedule a pickup or a delivery, print a manifest and shipping label, and prompt the operator through a process of packaging the donated item (or items) for shipment.

In some embodiments, the retail price of the donated item may be associated with the donated item in a database, placing a donation value on the item that can be used for tax purposes. Further, in some embodiments, such as when the donated item represents an incomplete donation of a multi-pack item that is not for individual shipment, the sorter device may be configured to determine a weight of the donated item and may automatically adjust the donation value proportionally. Other embodiments are also possible.

In some embodiments, the delivery of the donated item or items may include a delivery confirmation or receipt from a representative of the donation site. The delivery confirmation or receipt may be digitized and stored with the donation records, providing documentation of each donation, its value, and its delivery.

As used herein, the phrase “unsaleable item” or “unsaleable product” may be understood to refer to products with damaged packaging, irregular looking products (e.g., bent or irregular shaped carrots), blemished fruit, products (food, clothing, etc.) that do not sell or that are slow to sell, partial packages of a multi-pack product (e.g., undergarments, cleaning supplies, or other items), customer-returned products, other products, or any combination thereof. Such unsaleable items or unsaleable products may still be useable even if they cannot be sold.

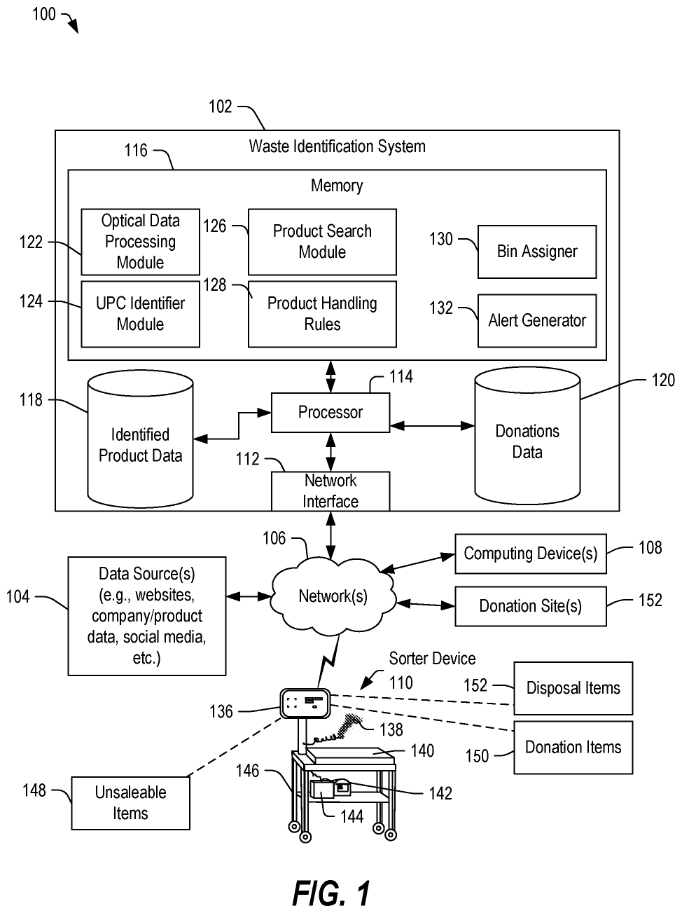

Embodiments of the systems, methods, and devices described below may be configured to facilitate donations of unsaleable items to donation sites, which may be able to utilize the unsaleable items. Food items, clothing, toys, household products, other items, or any combination thereof may be donated and repurposed by the donation site so that unsaleable items do not have to be destroyed or discarded. Moreover, the value of the donation and its receipt can be documented for tax purposes. Additionally, donation sites, such as food kitchens, homeless shelters, and various other donation sites may benefit by receiving items that might otherwise be discarded. One possible example of a system to facilitate donations of unsaleable inventory is described below with respect to FIG. 1.

FIG. 1 depicts a block diagram of a system 100 configured to facilitate donations of unsaleable inventory, in accordance with certain embodiments of the present disclosure. The system 100 may include a waste identification system 102 that may be communicatively coupled to a sorter device 110, one or more data sources 104, one or more computing devices 108, and one or more donation sites 152 through a network 106. The network 106 may include the Internet; cellular, satellite, and digital communications networks; public switched telephone networks; short-range wireless networks, or any combination thereof.

The sorter device 110 may include optical sensors (such as cameras, bar code scanners 138, other optical sensors, or any combination thereof), a scale 140, a processor, a display 136, and an input interface. In some embodiments, the display 136 may be a touchscreen display configured to display data and user-selectable elements (such as buttons, text fields, clickable links, pull-down menus, and other selectable elements) and configured to receive input data based on interactions with the user-selectable elements.

In some embodiments, the sorter device 110 may be coupled to a moveable cart 146. The sorter device 110 can be configured to be used by an operator to scan and weigh unsaleable items. The sorter device 110 may automatically identify the unsaleable product or item based on the optical data, determine whether the unsaleable product or item can be donated, and, if so, provide a graphical interface to the display 136 of the sorter device 110 prompting the operator to select one of a plurality of donation sites or to confirm a recommended donation site. Once selected or confirmed, the sorter device 110 may print a label and optionally a manifest and provide a prompt within the graphical display instructing the operator what to do with the donated item. Additionally, the sorter device 110 may send a message to an operator of the selected donation site 152 including information about the donated item or items and including a request for acceptance or authorization to receive the donated items. Once the authorization or acceptance is received, the sorter device 110 may automatically schedule delivery or may schedule delivery in response to information received with the authorization or acceptance. In some embodiments, the sorter device 110 may provide a graphical interface to the display 136 prompting the operator to schedule the delivery (or pickup). Further, the delivery may require the recipient to sign the shipping manifest (paper or electronic) to confirm receipt. The signed shipping manifest may be scanned or otherwise captured and stored with a donation record in a memory of the sorter device 110.

In some embodiments, the sorter device 110 may be used by an operator to scan a plurality of unsaleable items or products 148 one at a time. The sorter device 110 may identify the item, determine whether the item can be donated according to product handling rules and regulations, and provide a graphical interface to the display 136 when the item can be donated prompting the operator to place the item into a bin of donation items 150. In some embodiments, there may be a bin for each donation site so that the operator can sort the donations into a bin of donations items 150 specific to the selected donation site.

If the item cannot be donated, the sorter device 110 may provide a graphical interface to the display 136 providing instructions to the operator including a bin assignment for storage of disposal items 152. In some embodiments, an unsaleable item may be scanned, and the sorter device 110 may be unable to identify the item or may be unable to determine whether the item can be donated in which case the sorter device 110 may communicate scanned data to the waste identification system 102 to determine how to handle the unsaleable item.

The waste identification system 102 may include a network interface 112 configured to communicate with the network 106. Further, the waste identification system 102 may include a processor 114 coupled to the network interface 112. The waste identification system 102 can also include a memory 116 coupled to the processor 114 and configured to store data and instructions that, when executed, may cause the processor 114 to identify and classify a waste product based on information received from the sorter device 110 and optionally one or more data sources 104. The waste identification system 102 may further include a database of identified product data 118 and a database of site-specific classification rules 120. In some embodiments, the identified product data 118 and the site-specification classification rules 120 may be stored in the memory 116.

The memory 116 may include an optical data processing module 122 that, when executed, may cause the processor 114 to receive optical data associated with an unsaleable product from the sorter device 110 and to extract data from the optical data, such as a UPC, a serial number, a product name, other information, or any combination thereof. The memory 116 may further include a UPC identifier module 124 that, when executed, may cause the processor 114 to utilize the data extracted by the optical data processing module 122 to identify a UPC code within the optical data.

The memory 116 can also include a product search module 126 that, when executed, may cause the processor 114 to search the identified product database 118, one or more data sources 104, or any combination thereof to identify the unsaleable product associated with the UPC code data. In some embodiments, the product search module 126 may provide a query to a computing device 108 or other system the retailer associated with the sorter device 110 to determine product information associated with the UPC and the system may provide results to the product search module 126 in response to the query.

The memory 116 can further include a product handling rules 128 that, when executed, may cause the processor 114 to determine product handling guidelines for a particular unsaleable product. The product handling guidelines may specify whether and under what conditions a particular unsaleable item can be repurposed and, if not, how to dispose of the unsaleable item.

The memory 116 may include a bin assigner 130 that, when executed, may cause the processor 114 to determine a disposal bin into which the unsaleable product should be placed. In some embodiments, the memory 116 may further include an alert generator 132 that, when executed, may cause the processor 114 to generate an alert to the sorter device 110. The alert sent to the sorter device 110 may include a message that the previously unknown item has been identified. The alert may further indicate that the unsaleable product can be donated, which may cause the sorter device 110 to present a graphical display including selectable options accessible by the operator to select a donation site for the unsaleable item. Otherwise, the alert may include an assigned disposal bin and may include instructions to rescan the waste item. Further, the alert may include an update to a local database of the sorter device 110 so that subsequent scans of similar items can be readily identified and classified. In some embodiments, the alert generator 134 may also send a message to other item sorters through the network 106 to update their local databases with identification/classification information, making it possible for other item sorters to benefit from the completed “round trip” identification. Other embodiments are also possible.

It should be appreciated that the sorter device 110 may include a computing device, which may be integrated within the display 136. The computing device may be coupled to a barcode reader 138 or other optical scanning device. Further, the computing device 136 may be coupled to a scale 140 and to a printer 142, such as a label printer. The computing device may also receive power from a power supply, such as a battery 144, which allows the sorter device 110 to be portable. In some embodiments, the computing device, the barcode reader 138, the scale 140, the printer 142, the display 136, and the battery 144 may be coupled to a table or cart 146. In this example, the cart 146 includes wheels, which may allow the user to move the sorter device 110 as needed. Other embodiments are also possible.

In operation, the sorter device 110 may be utilized by an operator to scan a plurality of unsaleable items to determine whether a particular item can be donated or if the item must be disposed of. When the item can be donated, the graphical interface provided to the display 136 may enable an operator to select between or otherwise specify a donation site from a plurality of donation sites 152. It should be understood that the term “donation site” refers to an intended recipient of the donated item.

Once an unsaleable item is assigned to a donation site, the sorter device 110 may send an alert or other message to a computing device associated with the donation site, requesting acceptance and/or authorization to donate the item to the donation site. Upon receipt of acceptance or authorization, the sorter device 110 may provide a graphical interface configured to provide prompts and instructions configured to guide an operator through a process of packaging the donated items and arranging for delivery or pickup of the donated items. The sorter device 110 may print a shipping manifest and a label for the shipping container. Additionally, in some embodiments, the sorter device 110 may track the donation from packaging through delivery, including capturing a signature or other indication acknowledging receipt by the donation site, and may store the manifest, shipping data, and receipt data in a memory. In some embodiments, the donation package (manifest, shipping data, and receipt data) may be sent through the network 106 to a corporate headquarters or stored by the waste management system 102 in a database of donations data 120. Other embodiments are also possible.

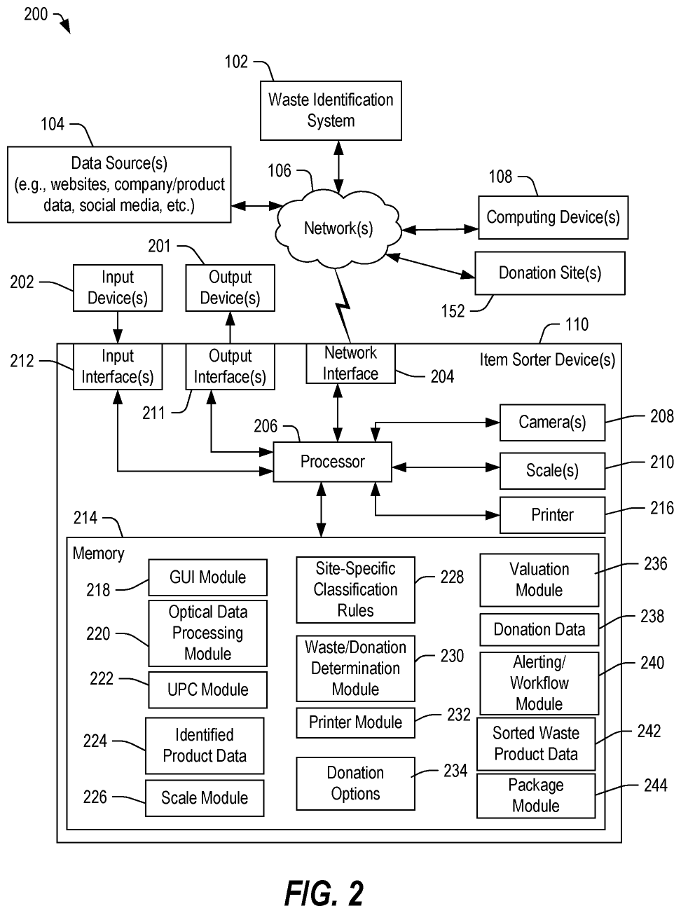

FIG. 2 depicts a block diagram 200 of the waste product identification system 100 including a waste identification system 102 coupled to one or more item sorter devices 110, in accordance with certain embodiments of the present disclosure. The waste identification system 102 may be coupled to one or more data sources 104, one or more computing devices 108, one or more sorter devices 110, and one or more donation sites 152 through a communications network 106.

Each sorter device 110 may be configured to couple to one or more output devices 201 (such as the display 136 in FIG. 1) and to one or more input devices 202, such as a keyboard, a stylus, a mouse, a scanner, another input device, or any combination thereof. In some embodiments, a display device (i.e., display 136 in FIG. 1) may be implemented as a touchscreen, which may thus operate as both an output device 201 and an input device 202. The sorter device 102 may include a network interface 204, which may be configured to send and receive data and optionally processor-readable instructions to the waste identification system 102 through the network 106. The sorter device 110 may also include a processor 206 coupled the network interface 204.

The sorter device 110 may further include one or more cameras (or optical sensors) 208 configured to capture image data, one or more scales 210 (or pressure transducers), and one or more printers 216, which may be configured to print manifests, labels, and other documents. The item sorter device 110 may include one or more output interfaces 211 configured to couple to the one or more output devices 201, and may include one or more input interfaces 212 configured to couple to the one or more input devices 202. The processor 206 may be coupled to the one or more cameras 208, the one or more scales 210, the one or more printers 216, the one or more output interfaces 211, and the one or more input interfaces 212. Further, the sorter device 110 may include a memory 214 that is coupled to or otherwise accessible to the processor 206 and that is configured to store data and instructions that may be executed by the processor 206.

The memory 214 may include a graphical user interface (GUI) module 218 that, when executed, may cause the processor 206 to generate a graphical interface including data and including user-selectable elements accessible by a user to enter information and to make selections. In some embodiments, the processor 206 may provide the graphical interface to a display 136 (output device 201) via the output interface 211 or to a touchscreen display. The graphical interface may include instructions to guide an operator (an employee tasked with sorting unsaleable products) through a process of scanning and sorting unsaleable items into bins for donation, reuse, or disposal.

The memory 214 may further include an optical data processing module 220 that, when executed, may cause the processor 206 to control the one or more cameras 208 to capture optical data associated with an unsaleable product or item. The memory 214 may also include a UPC module 222 that, when executed, may cause the processor 206 to parse and analyze the optical data to determine UPC data, image data, or any combination thereof. Additionally, the UPC module 222 may cause the processor 206 to compare the extracted UPC data to UPC data stored in the identified product data 224 to identify the unsaleable product. The memory 214 may further include a scale module 226 that, when executed, may cause the processor 206 to control the one or more scales 210 to determine a weight of the unsaleable product.

The memory 214 may also include site-specific classification rules 228 that, when executed, may cause the processor 206 to determine one or more bins into which the unsaleable product can be stored and to communicate information identifying the bin for presentation within the graphical interface on the display (output device 201 or display 136). The memory 214 may further include a waste/donation determination module 230 that, when executed, may determine whether the unsaleable product can be donated or reused, or if the unsaleable product must be placed in a disposal bin. In an example, liquid bleach may require disposal, while an overstock of bread, unsold clothing, certain cleaning products (such as wipes), and other products could be donated. A selectable option to donate the unsaleable item may be included within the graphical interface if the unsaleable item can be donated, otherwise the selectable option for donation may be omitted.

The memory 214 may also include a printer module 232 that, when executed, may cause the processor 206 to control the printer 216 to generate a label for the bin, a shipping manifest, a label for a shipping container, other information, or any combination thereof. The memory 214 may include a plurality of donation options 234, which may include a list of donation sites, the types of products that each donation site can accept as a donation, delivery or pickup information, contact information, other information, or any combination thereof. Additionally, the memory 214 may include a valuation module 236, which may capture the retail value of the unsaleable item from a store database. The valuation module 236 may also compare the weight of the item, as determined by the scale 210, to the expected weight based on a product record of the store database to determine if the donation is 100% of the item, or if the donation is a portion of the item. For example, if one container of a multipack product is damaged, the unsaleable item that is donated may be a partial product, and the valuation module 236 may adjust the value of the donated item proportionally.

The memory 214 may include an alerting/workflow module 240 that, when executed, may cause the processor 206 to perform a variety of functions. First, upon receipt of a selection of a particular donation site for donation of a particular unsaleable item, the alerting/workflow module 240 may cause the processor 206 to send a message to a contact email or phone number associated with the donation site seeking an acceptance/authorization to donate the item to that particular site. The alert may include information about the donation including the product name, the quantity, the expiration date, and so on. If the donation site does not have room for the donation or cannot make use of the donation in a timely manner (for example, based on the expiration date), the user at that site may refuse the donation, causing a response to be sent to the sorter device 110. Upon receipt of a refusal, the GUI module 218 may present a graphical interface to the display 136 (output device 201) that includes an indication that the donation site refused the donation and presenting other possible donation site options for selection. The process may then be repeated for the next selected donation site.

If the donation site accepts the donation, the alerting/workflow module 240 may cause the processor 206 to update donation data 238 in the memory 214 to include a record for the donation including the manifest information, the valuation information, and donation site information for the donation of the unsaleable item(s). Further, the alerting/workflow module 240 may cause the printer module 232 to print the manifest and shipping label for the donation using the printer 216. Further, the alerting/workflow module 240 may cause the processor 206 to execute the package module 244, which may cause the processor 206 to execute the GUI module 218 to provide a graphical interface to the display 136 guiding the operator through a process of packaging the donated unsaleable items into a shipping container.

If the waste/donation determination module 230 causes the processor 206 to determine that the unsaleable item cannot be donated, the processor 206 may execute the GUI module 218 to provide instructions for sorting the waste item into a suitable disposal bin of a plurality of disposal bins. Further, the memory 214 can include sorted waste product data 242, and the waste/donation determination module 230 may cause the processor 206 to update the sorted waste product data 242 to reflect the unsaleable item. In an example, the memory 214 may store sorted waste product data 242, including manifest data, packaging data, and other data, which may provide an audit trail for waste product handling and disposal. Similarly, the memory 214 stores donation data 238, which may include manifest data (product identifier, weight, value, other data, or any combination thereof), packaging data (date, time, operator name, total package weight, other data, or any combination thereof), delivery data (pickup or deliver, date of pickup or delivery, confirmation of pickup or deliver, other data, or any combination thereof), and so on. Other embodiments are also possible.

In some embodiments, the alerting/workflow module 240 may be configured to communicate data, such as donation package data and sorted waste product package data, to the waste identification system 102 or to a computing device 108, which may be associated with a company. Other embodiments are also possible.

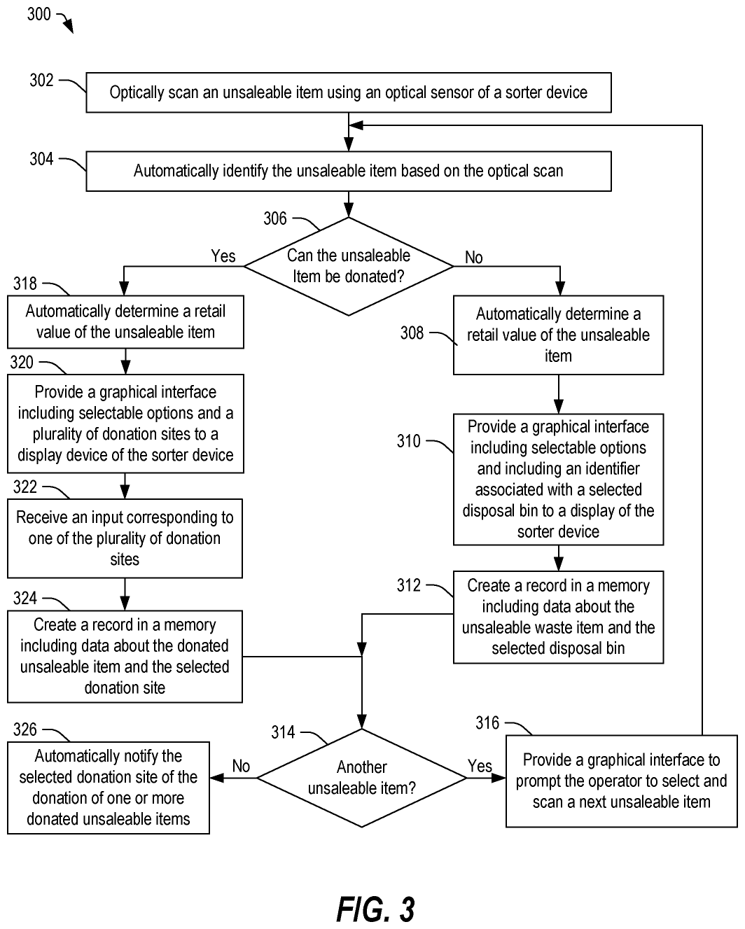

FIG. 3 depicts a method of 300 donating an unsaleable item, in accordance with certain embodiments of the present disclosure. At 302, the method 300 can include optically scanning an unsaleable item using an optical sensor of a sorter device 110. Optically scanning may include directing a barcode reader device toward the unsaleable item, placing the unsaleable item on a scale toward which one or more cameras may be directed, or any combination thereof.

At 304, the method 300 can include automatically identifying the unsaleable item based on the optical scan. Identifying the unsaleable item may include searching a product database based on the optical data (such as a universal product code (UPC) determined from the optical data) to determine a match and retrieving data related to the unsaleable item based on the match.

At 306, the method 300 can include determining whether the unsaleable item can be donated. If, at 306, the unsaleable item cannot be donated, the method 300 may include automatically determining a retail value of the unsaleable item, at 308. It should be appreciated that the retail value may vary depending on the state of the product. In the case of an intact item, the retail value may be the actual store price. In the case of a partial item, such as a missing item from a multi-pack product, the retail value may be adjusted proportionally, for example, based on the weight of the unsaleable item relative to an expected total weight of the multi-pack product. Other embodiments are also possible.

At 310, the method 300 can include providing a graphical interface including selectable options and including an identifier associated with a selected disposal bin to a display of the sorter device. The system may include multiple disposal bins, where each bin secures and stores unsaleable items that cannot be contained and that share common characteristics.

At 312, the method 300 can include creating a record in a memory including data about the unsaleable waste item and the selected disposal bin. At 314, if there is another unsaleable item, the method 300 may include providing a graphical interface to prompt the operator to scan a next unsaleable item, at 316. The method 300 may then return to 304 to automatically identify the unsaleable item based on the optical scan.

At 306, if the unsaleable item can be donated, the method 300 may include automatically determining a retail value of the unsaleable item, at 318. At 320, the method 300 may include providing a graphical interface including selectable options and a plurality of donation sites to a display of the sorter device. The donation sites may include non-profit entities that can make use of donated items. In an example, each donation site may differ with respect to the types of items it can accept. For example, some donation sites may accept clothing and other non-perishable goods, while other donation sites may accept perishable items, such as food. In some embodiments, the plurality of donation sites provided to the graphical interface may be limited to those donation sites that accept the type or category of goods into which the unsaleable item falls. Other embodiments are also possible.

At 322, the method 300 can include receiving an input corresponding to one of the plurality of donation sites. The input can include a selection of a donation site from the plurality of donation sites.

At 324, the method 300 may include creating a record in a memory including data about the donated unsaleable item and the selected donation site. Advancing to 314, if there is another unsaleable item to be sorted, the method 300 can return to 316. Otherwise, the method 300 may include automatically notifying the selected donation site of the donation of one or more donated unsaleable items, at 326. The sorter device 110 may, for example, send an email message, a text message, or a voice message to a computing device or system of the selected donation site.

In some embodiments, the donation process may be complete at this point, except that an operator may need to place the donated item or items into a shipping container together with a manifest. In other embodiments, the donation process may include sending an email or other digital communication including an offer to donate one or more unsaleable items to a donation site. An operator at the donation site may respond by accepting the offer or by declining the offer. If the offer is declined, the sorter device may present an updated list of donation sites to the operator for a new selection, and then the process can be repeated. Otherwise, if the offer is accepted, the operator may be prompted to package the donated unsaleable items into a shipping container for transport and delivery.

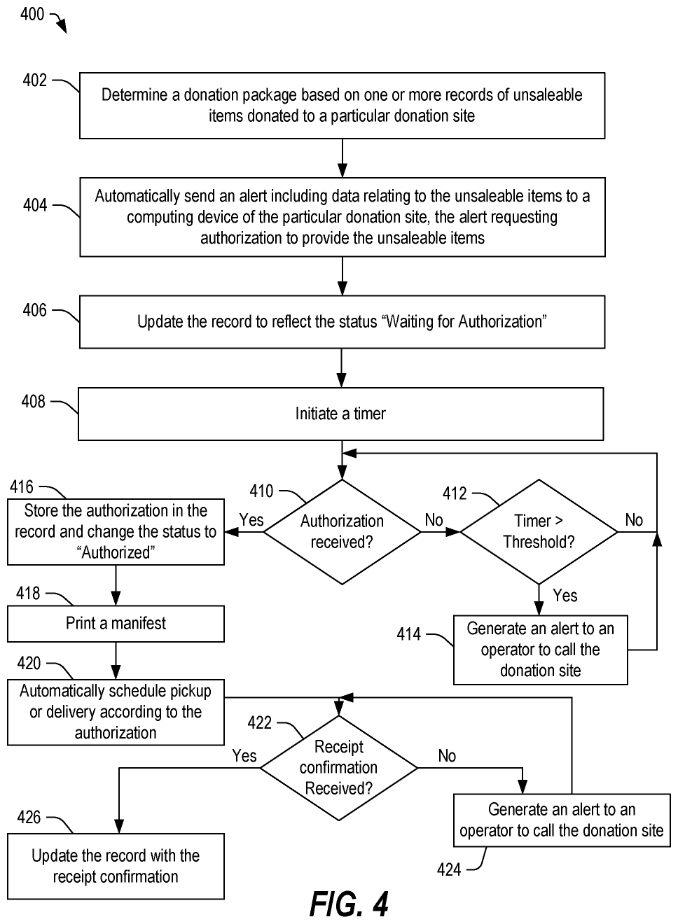

In some embodiments, it may be important to document the donations of the unsaleable items for inventory, tax, and other purposes. In some instances, documenting the donations can include storing data related to the shipping manifest, the value of each item, and documentation of the receipt by the donation site. One possible embodiment of a method that includes receiving authorization to donate the items as well as confirmation of receipt of the donated items is described below with respect to FIG. 4.

FIG. 4 depicts a method 400 of donating an unsaleable item, in accordance with certain embodiments of the present disclosure. At 402, the method 400 can include determining a donation package based on one or more records of unsaleable items donated to a particular donation site. In an example, a set of donated unsaleable items may be grouped together into a package of donated items. The donation package may include a plurality of donated unsaleable items placed into a shipping container.

At 404, the method 400 can include automatically sending an alert including data relating to the donated unsaleable items to a computing device of the particular donation site, the alert requesting authorization to provide the unsaleable items. The alert may include information about the donation, including identifiers of each unsaleable product of a plurality of donated unsaleable products, a total weight of the products, a quantity of each of the products, an expiration date (if any) of each of the products, and so on.

At 406, the method 400 can include updating the record to reflect the status “Waiting for Authorization.” At 408, the method 400 may include initiating a timer 408. The timer may count in hours, days, or another predetermined period of time. In some instances, the timer may be determined dynamically based on the urgency of the donation, such as based on an expiration date of at least one item of the donation package.

At 410, the method 400 includes determining if the authorization has been received. If no authorization has been received at 410, the method 400 may include determining if the timer exceeds a threshold time, at 412. If the timer does not exceed the threshold time at 412, the method 400 returns to 410 to determine if authorization has been received. Otherwise, at 412, if the timer exceeds the threshold, the method 400 includes generating an alert to an operator to call the donation site, at 414. The alert may be presented to a display within a graphical interface, sent as a text to a smartphone, sent as a call to a smartphone, or any combination thereof. The method 400 then returns to 412 to determine if the authorization has been received.

Returning to 410, if authorization is received, the method 400 can include storing the authorization in the record and changing the status to “Authorized,” at 416. It should be appreciated that, if the authorization response is “No,” the method 400 could include providing a graphical interface to the display of the sorter device 110 to prompt the operator to select a new donation site from the list. The method 400 assumes that the authorization response from the donation site is “Yes.”

At 418, the method 400 can include printing a manifest of the donated unsaleable items that are donated to a particular donation site. At 420, the method 400 can include automatically scheduling a pickup or delivery according to the authorization. In an example, the authorization may specify whether the donation is to be picked up or delivered. Further, the authorization may specify particular instructions related to delivery. Other embodiments are also possible.

At 422, the method 400 determines whether a receipt confirmation is received. If the receipt confirmation is not received at 422, the method 400 may include generating an alert to an operator to call the donation site, at 424. The alert may be presented to a display within a graphical interface, sent as a text to a smartphone, sent as a call to a smartphone, or any combination thereof. The method 400 may then return to 422 to determine if the receipt confirmation has been received.

Returning to 422, if the receipt confirmation has been received, the method 400 may include updating the record with the receipt confirmation, at 426. In some embodiments, the receipt confirmation may include a digital signature, an image of a signature, a scan or digital image of the manifest signed by a receiver at the donation site, or any combination thereof.

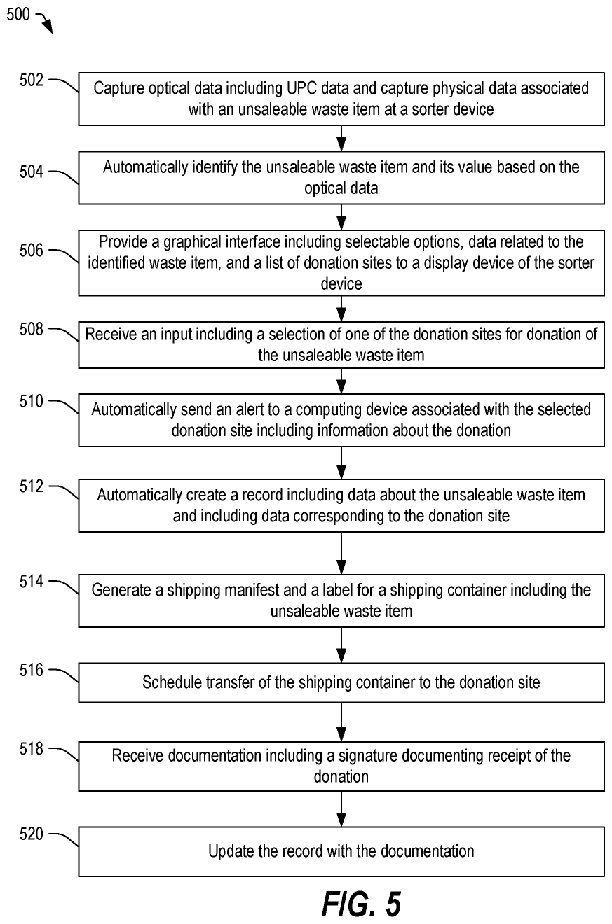

FIG. 5 depicts a method 500 of donating an unsaleable item, in accordance with certain embodiments of the present disclosure. At 502, the method 500 may include capturing optical data including UPC data and capture physical data associated with an unsaleable waste item at a sorter device. The optical data may be captured using one or more cameras, one or more barcode readers, one or more optical sensors, or any combination thereof.

At 504, the method 500 may include automatically identifying the unsaleable waste item and its value based on the optical data. It should be appreciated that the unsaleable waste item, in this example, has been determined to be capable of being donated according to a set of waste handling rules. Further, the value may include the retail price, which may be adjusted according to any difference between the item that could be sold normally at retail as compared to the unsaleable item. For example, if part of the multi-pack item is damaged or missing, the retail price for the unsaleable item may be adjusted proportionally.

At 506, the method 500 may include providing a graphical interface including selectable options, data related to the identified waste item, and a list of donation sites to a display device of the sorter device. At 508, the method 500 can include receiving an input including a selection of one of the donation sites for donation of the unsaleable waste item. The input may be received through a touchscreen interface or via a keyboard or pointing device in conjunction with one of the selectable options within the graphical interface.

At 510, the method 500 may include automatically sending an alert to a computing device associated with the selected donation site including information about the donation. The alert may be an electronic message, a call, or another alerting mechanism. The information about the donation may include item identifiers, quantities, expiration dates (if any), and so on.

At 512, the method 500 may also include automatically creating a record including data about the unsaleable waste item and including data corresponding to the donation site. At 514, the method 500 can include generating a shipping manifest and a label for a shipping container including the unsaleable waste item.

At 516, the method 500 may include scheduling a transfer of the shipping container to the donation site. The transfer may be a pickup or a delivery, depending on the particular donation and donation site. At 518, the method 500 can include receiving documentation including a signature documenting receipt of the donation. The documentation may be digital, with a receiver digitally signing on a touch-sensitive interface of a portable device, or a scan of a paper document including the signature. At 520, the method 500 may include updating the record with the documentation. Other embodiments are also possible.

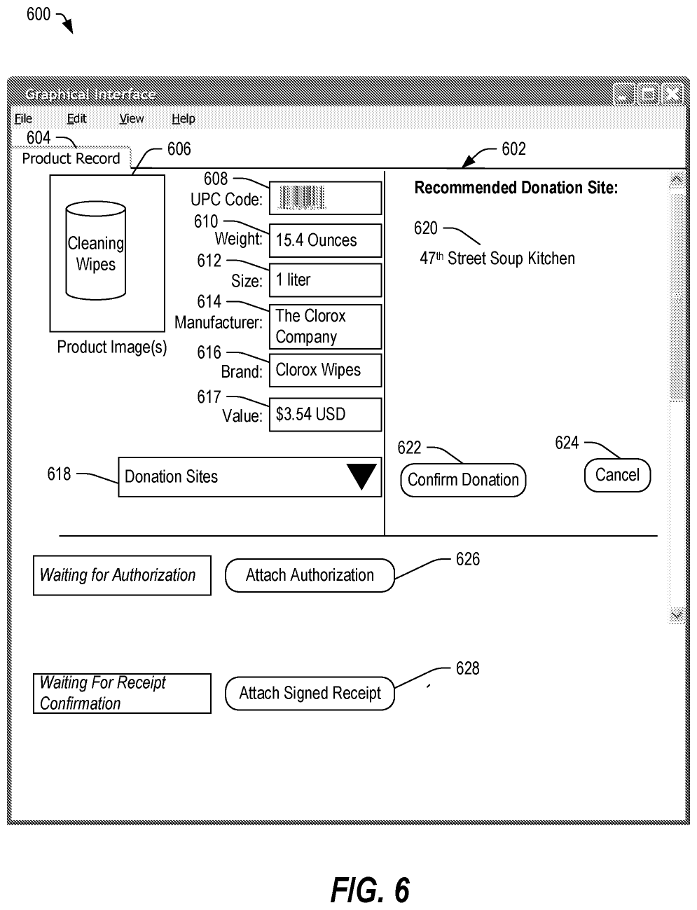

FIG. 6 depicts a graphical interface 600 for presentation to a display of the item sorter device of FIGS. 1 and 2, in accordance with certain embodiments of the present disclosure. The graphical interface 600 may include data, generally indicated at 602, representing a particular unsaleable item. The graphical interface 600 may include a product record 604 including an image 606 of the product, a UPC code 608 determine from the image data, and a weight 610 determined from the scale. The graphical interface 600 may further include a container size 612, a manufacturer name 614, and a brand name 616 determined from a match of the UPC code to store records. The graphical interface 618 may further include a pull-down menu 618, which may be accessed by the operator to select a donation site from a plurality of donation sites that can accept Clorox® wipes as a donation.

In some embodiments, the graphical interface 600 may also include a recommended donation site 620. The graphical interface 600 can also include a “Confirm Donation” button 622, which may be accessed by an operator to confirm the recommended donation 620. If the operator accesses the pull-down menu 618 to select a donation site other than the recommended site 620, the graphical interface 600 may update the recommended donation site 620 with the selected donation site. The operator may then confirm the donation site by selecting the “Confirm Donation” button 622. Otherwise, the graphical interface 600 may include a “Cancel” button 624, which can be accessed by an operator to cancel the donation process. Other embodiments are also possible.

In the illustrated example, a container from a multi-pack of Clorox® wipes can be donated to the 47^{th} Street Soup Kitchen (indicated at 620) for use. The product is assigned a retail value 617, which, in this case, may be proportional to the retail product value and reduced proportionally based on the weight of the donated unsaleable item. It should be appreciated that the value 617 presented is made up and is provided for illustrative purposes only.

The graphical interface 600 may further include a selectable button 626 to attach an authorization confirming acceptance or approval of the donation. Selection of the button 626 causes a popup window to open, allowing the operator to browse to locate a document to upload. The document may be an email, a signed digital form, a scan of a signed document, another indication of authorization, or any combination thereof. The graphical interface 600 may also include a selectable button 628 accessible by an operator to attach a signed receipt indicating acceptance or receipt of the donation at the donation site. The signed receipt may take any form that is acceptable to the accounting department of the store and optionally the Internal Revenue Service. Other embodiments are also possible.

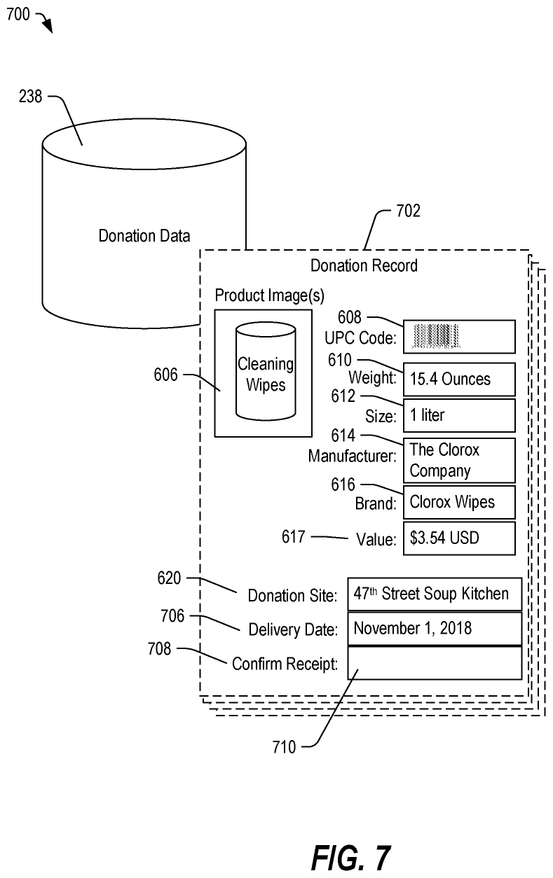

FIG. 7 depicts a diagram 700 of a partial donation record 702, in accordance with certain embodiments of the present disclosure. The diagram 700 includes the donation data 238 (of FIG. 2), which can include a plurality of records 702. Each donation record 702 can include the image data 606, UPC code 608, weight 610, size 612, manufacturer name 614, brand name 616, value 617, and donation site 620, which were shown in the graphical interface 600 of FIG. 6.

In this example, the donation record 702 may include a delivery date field 706 that can store a date corresponding to the delivery date (or scheduled delivery date) for the donation package. The donation record 702 may also include a confirm receipt 708. In this example, the confirm receipt field 710 is empty because the receipt either hasn't been received or has not yet been uploaded yet.

In conjunction with the systems, devices, methods, and interfaces described above with respect to FIGS. 1-7, a sorter device may include one or more optical sensors configured to capture optical data associated with an unsaleable item. The sorter device may identify the unsaleable item, determine its value, and assign the unsaleable item to a selected donation site. The sorter device may be further configured to guide an operator through a process of packaging the donated unsaleable items into a shipping container, attaching a printed manifest, confirming acceptance, and receiving confirmation of receipt of the donation. Other embodiments are also possible

Although the present invention has been described with reference to preferred embodiments, workers skilled in the art will recognize that changes may be made in form and detail without departing from the scope of the invention.

What is claimed is:

1. A sorter device comprising:
at least one optical device configured to capture optical data associated with an unsaleable item;
a display; and
a processor coupled to the at least one optical device and to the display, the processor configured to:
automatically identify the unsaleable item from the optical data;
determine a recommended donation site from a plurality of donation sites for the unsaleable item based on the identification; and
provide a graphical interface to the display indicating the recommended donation site.

2. The sorter device of claim 1, wherein the sorter device further comprises a scale coupled to the processor and configured to determine a weight of the unsaleable item.

3. The sorter device of claim 2, wherein the processor is further configured to determine a value of the unsaleable item based on a retail price and a weight of the unsaleable item.

4. The sorter device of claim 1, further comprising a printer coupled to the processor and configured to print a manifest and a shipping label for a shipping container including the unsaleable item.

5. The sorter device of claim 1, wherein processor is configured to determine the donation site based on identification of the unsaleable item and based on a type item that can be accepted by the donation site.

6. The sorter device of claim 1, wherein the processor is configured to:
automatically send an alert to a computing device of the donation site through a network to determine whether the donation site will accept a donation of the unsaleable item; and
provide the graphical interface including instructions to package the unsaleable item in a shipping container in response to receiving an indication of acceptance; and
provide the graphical interface including a prompt to select a different donation site of the plurality of donation sites in response to receiving an indication of rejection.

7. The sorter device of claim 6, wherein, when a response to the alert is not received within a period of time, the processor provides the graphical interface including instructions to contact the donation site.

8. The sorter device of claim 1, wherein the processor is further configured to:
provide the graphical interface including a delivery date and including data related to confirmation of receipt of the donation when the confirmation of receipt is received; and
when the confirmation of receipt is not received, provide the graphical interface including instructions to contact the donation site to acquire the confirmation of receipt.

9. A sorter device comprising:
at least one optical device configured to capture optical data associated with an unsaleable item;
a display; and
a processor coupled to the at least one optical device and to the display, the processor configured to:
automatically identify the unsaleable item from the optical data;
determine whether the identified unsaleable item can be donated based on a set of product handling rules;
automatically determine a recommended donation site from a plurality of donation sites for the identified unsaleable item based on the identification when the identified unsaleable item can be donated; and
provide a graphical interface to the display indicating the recommended donation site.

10. The sorter device of claim 9, wherein, when the identified unsaleable item cannot be donated based on the product handling rules, the processor is configured to:
select a disposal bin from a plurality of disposal bins based on information associated with the identified unsaleable item; and
provide the graphical interface including data corresponding to the selected disposal bin to the display.

11. The sorter device of claim 9, wherein the sorter device further comprises a scale coupled to the processor and configured to determine a weight of the unsaleable item.

12. The sorter device of claim 11, wherein the processor is further configured to determine a value of the unsaleable item based on a retail price and the weight of the unsaleable item.

13. The sorter device of claim 9, further comprising a printer coupled to the processor and configured to print a manifest and a shipping label for a shipping container including the unsaleable item.

14. The sorter device of claim 9, wherein processor is configured to determine the donation site based on identification of the unsaleable item and based on a type item that can be accepted by the donation site.

15. The sorter device of claim 9, wherein the processor is configured to:
automatically send an alert to a computing device of the donation site through a network to determine whether the donation site will accept a donation of the unsaleable item; and
provide the graphical interface including instructions to package the unsaleable item in a shipping container in response to receiving an indication of acceptance; and
provide the graphical interface including a prompt to select a different donation site of the plurality of donation sites in response to receiving an indication of rejection.

17. The sorter device of claim 15, wherein, when a response to the alert is not received within a period of time, the processor provides the graphical interface including instructions to contact the donation site.

18. The sorter device of claim 9, wherein the processor is further configured to:
provide the graphical interface including a delivery date and including data related to confirmation of receipt of the donation when the confirmation of receipt is received; and
when the confirmation of receipt is not received, provide the graphical interface including instructions to contact the donation site to acquire the confirmation of receipt.

19. A method comprising:
scanning an unsaleable item using an optical sensor of a sorter device to capture optical data;
automatically identifying the unsaleable item based on the optical data using a processor of the sorter device;
automatically selecting a donation site of a plurality of donation sites based on information corresponding to the identified unsaleable item; and
providing a graphical interface to a display of the sorter device, the graphical interface including the selected donation site.

20. The method of claim 19, further comprising:
determining a weight of the unsaleable item using a scale of the sorter device; and
determining a value of the unsaleable item based on a retail price of the unsaleable item and based on the weight.
